(19) United States
(12) Patent Application Publication
(10) Pub. No.: US 2015/0039453 A1
(43) Pub. Date: Feb. 5, 2015

(54) NGO ELECTRONIC TRANSACTION MANAGEMENT SYSTEM AND METHOD

(71) Applicant: MasterCard International Incorporated, Purchase, NY (US)

(72) Inventors: Paul Michael Musser, Pilot Hill, CA (US); Stefany Bello Lopez, White Plains, NY (US); Melisa Rose Favuzza, O'Fallon, MO (US); Kathryn Lynn Genereux, Brooklyn, NY (US); April DuBois, Great Falls, VA (US)

(21) Appl. No.: 14/485,390

(22) Filed: Sep. 12, 2014

Related U.S. Application Data
(63) Continuation-in-part of application No. 14/308,400, filed on Jun. 18, 2014.
(60) Provisional application No. 61/876,896, filed on Sep. 12, 2013.
(60) Provisional application No. 61/836,588, filed on Jun. 18, 2013.

(51) Int. Cl. G06Q 20/34; G06Q 20/40; G06Q 20/20

(52) U.S. Cl. CPC G06Q 20/34; G06Q 20/20; G06Q 20/40
USPC 705/16

(57) ABSTRACT

A system, method, and computer-readable storage medium configured to process financial transactions that traverse an NGO network with an interbank network.

### RELATED APPLICATIONS

This application claims priority to provisional U.S. Patent Application Ser. No. 61/876, 896, entitled “NGO Electronic Transaction Management System,” filed on Sep. 12, 2013, and is also a continuation in part of U.S. patent application Ser. No. 14/308, 400, entitled “Multi-Party Transaction Payment Network Bridge Apparatus and Method,” filed on Jun. 18, 2014, which claims priority to provisional U.S. Patent Application Ser. No. 61/836,588, entitled “Multi-Party Transaction Payment Network Bridge Apparatus and Method,” filed on Jun. 18, 2013.

### BACKGROUND

1. Field of the Disclosure

Aspects of the disclosure relate in general to financial services. Aspects include an apparatus, system, method and computer-readable storage medium to process financial transactions in a non-governmental organization (NGO) network.

2. Description of the Related Art

In the non-developed world, when a natural disaster or other calamity occurs, non-governmental organizations (NGOs) come and deliver aid to the stricken area. Traditionally, aid has come in the form of food, shelter, medicine, and other types of goods and services. However, distributing aid is a difficult logistical task and can lead into undesired consequences. Distributing aid vouchers may lead to voucher counterfeiting or theft of the voucher. Moving tons of free food into a stricken area may, for example, may put local farmers and merchants out of business, and damage local market economies.

More recently, non-governmental organizations have attempted to bolster local economies by distributing currency to victims. For centuries, financial transactions have used currency, such as banknotes and coins. In modern times, however, payment cards are rapidly replacing cash to facilitate payments. NGOs have attempted to use the security of payment cards by distributing aid as money or other stored value on a payment card. In such an system 1000, shown in FIG. 1, an NGO 1200 creates a closed-loop payment network 1100 (“NGO network”) among merchants 1110a-c in the stricken area. In some instances, automated teller machines (ATMs) 1120a-c may also be deployed in the stricken area.

An NGO payment network server 1300 processes transactions for goods and services on the NGO network 1100. Payment cards issued by the NGO are limited to participating merchants 1110 on the NGO network 1100. Similarly, a consumer using a payment card issued by a financial institution will not be able to user their payment card on the NGO network 1100.

### SUMMARY

Embodiments include a system, device, method and computer-readable medium to process financial transactions in a non-governmental organization network.

Embodiments include a method of processing a financial transaction. A network interface receives the aid transaction from a point-of-sale (POS) device. The aid transaction contains a cardholder identifier, and a merchant identifier. The processor validates the cardholder identifier. Using the cardholder identifier the processor retrieves a photograph of a cardholder associated with the cardholder identifier from a database stored on a non-transitory computer-readable storage medium. The network interface transmits the photograph of the cardholder to the point-of-sale device.

An apparatus embodiment processes a financial transaction. The apparatus comprises a network interface and a processor. The network interface receives the aid transaction from a point-of-sale (POS) device. The aid transaction contains a cardholder identifier, and a merchant identifier. The processor validates the cardholder identifier. Using the cardholder identifier the processor retrieves a photograph of a cardholder associated with the cardholder identifier from a database stored on a non-transitory computer-readable storage medium. The network interface transmits the photograph of the cardholder to the point-of-sale device.

A non-transitory computer-readable storage medium embodiment is encoded with data and instructions. When the instructions are executed by a computing device, causes the computing device to process a financial transaction. The network interface receives the aid transaction from a point-of-sale (POS) device. The aid transaction contains a cardholder identifier, and a merchant identifier. The processor validates the cardholder identifier. Using the cardholder identifier the processor retrieves a photograph of a cardholder associated with the cardholder identifier from a database stored on a non-transitory computer-readable storage medium. The network interface transmits the photograph of the cardholder to the point-of-sale device.

### BRIEF DESCRIPTION OF THE DRAWINGS

FIG. 1 illustrates a NGO network system of the PRIOR ART.

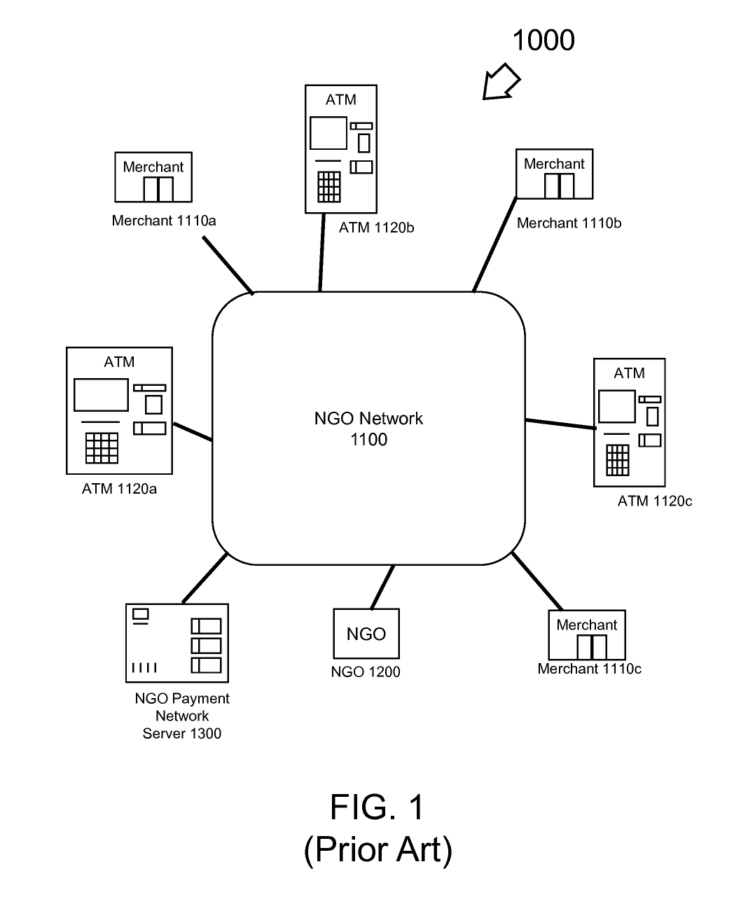

FIG. 2 depicts a system to process financial transactions that traverse an NGO network with an interbank network.

FIG. 3 is a block diagram of a payment network bridge configured to process financial transactions that traverse an NGO network with an interbank network.

FIG. 4 is a flow chart of a method of performing a financial transaction that crosses the NGO network with the interbank network.

FIG. 5 is a flow chart describing registration of a voucher aid program in a transaction management system.

FIG. 6 is a flow chart depicting a purchase transaction method using the transaction management system.

FIG. 7 is a flow chart of a method of a settlement method in the transaction management system.

### DETAILED DESCRIPTION

One aspect of the disclosure includes the realization that in some cases, an aid recipient may be mobile, and may travel as a refugee or visitor to areas not covered by a closed-loop NGO network. In such an instance, it would be useful for the aid recipient to be able to access funds or services at a merchant that is not connected to the NGO network.

Yet another aspect of the disclosure includes the understanding that a traveler from the developed world visiting an area covered by the NGO network may not be able to make payments at NGO-approved merchants using a standard payment card that uses an interbank network.

Another aspect of the disclosure includes the realization that a payment network bridge may be used to link an NGO payment network with an interbank network.

In another aspect of the disclosure, a payment network bridge may be used to facilitate secure financial transactions between an NGO payment network and an interbank network.

These and other aspects may be apparent in hindsight to one of ordinary skill in the art.

Embodiments of the present disclosure include a system, method, and computer-readable storage medium configured to enable an immediate online credit refund transaction.

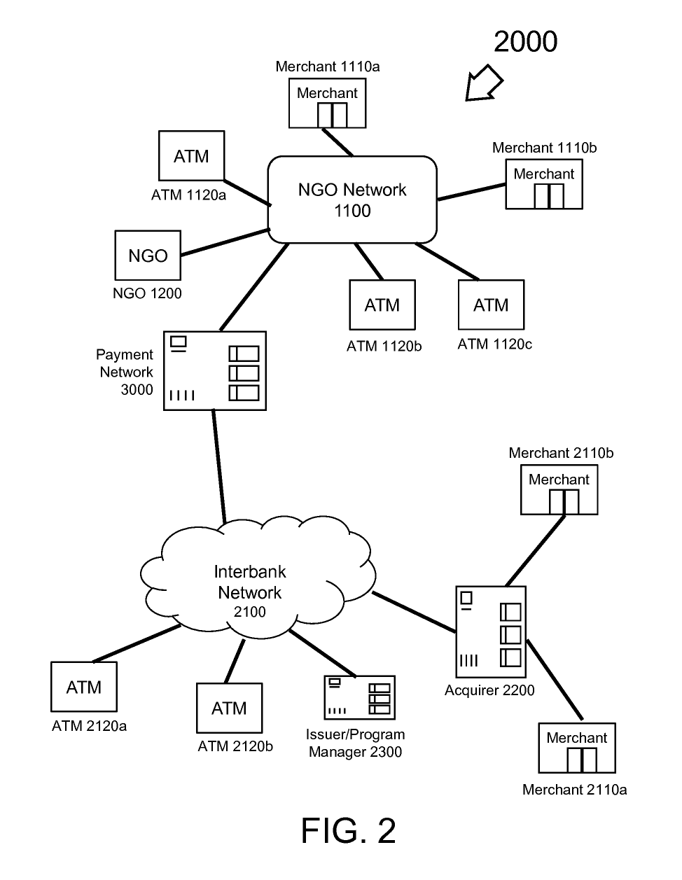

FIG. 2 depicts a system 2000 to link an NGO network 1100 with an interbank network 2100 via a payment network 3000, constructed and operative in accordance with an embodiment of the present disclosure. In such an embodiment, a non-governmental organization 1200 may distribute NGO-issued payment cards to aid recipients (“consumers”) for use at NGO-approved merchants 1110a-b, and ATMs 1120a-c. Transactions that take place within entities connected to the NGO network 1100 are processed by payment network 3000.

In parallel, payment network 3000 also processes financial transactions on an interbank network 2100, where payment card acquirer financial institutions 2200 (“acquirer”) and issuer financial institutions 2300 (“issuer”) may be connected.

Payment network 3000 is a payment network capable of processing payments electronically over NGO network 1100 and interbank network 2100. An example payment network includes MasterCard International Incorporated of Purchase, New York. Payment network 3000 may analyze and score financial transactions for the probability of fraud. The transaction scores may be expressed as a probability of fraud from zero (entirely fraudulent) to one (100% chance of no fraud), or scored between zero (fraudulent) and 1,000 (100% not fraudulent).

A merchant 1110 is any entity where the customer may redeem an aid voucher.

An acquirer 2200 is a bank, credit union, or other financial institution configured to process transaction data from merchants 1110a-b and prepares authorization formatted data for the payment network 3000.

An issuer 2300 is the bank, credit union, or other financial institution that provides the credit for the financial payment transaction. Issuer 2300 processes data (authorization requests), forwarded from the acquirer 2200 by interbank network 2100, and prepares the authorization formatted response (approvals/declines). In the following description, issuer 2300 acts as a program manager for a NGO payment network. A program manager is an entity, such as the non-governmental organization, that provides the aid voucher/token or other representation of the aid. Program manager contracts with a merchant 1110 to redeem the voucher, compensating merchant 1110 for their services, and sets the conditions for the voucher program. In the following example, issuer 2300 is a program manager. It is understood that in some embodiments, a program manager and issuer may be different entities. In some embodiments, issuer 2300 may be directly connected to the NGO network 1100.

In addition, automated teller machines 2120a-b may also be coupled to interbank network 2100.

As described below, because payment network 3000 processes financial transactions on NGO network 1100 and interbank network 2100, it may process transactions that bridge both networks.

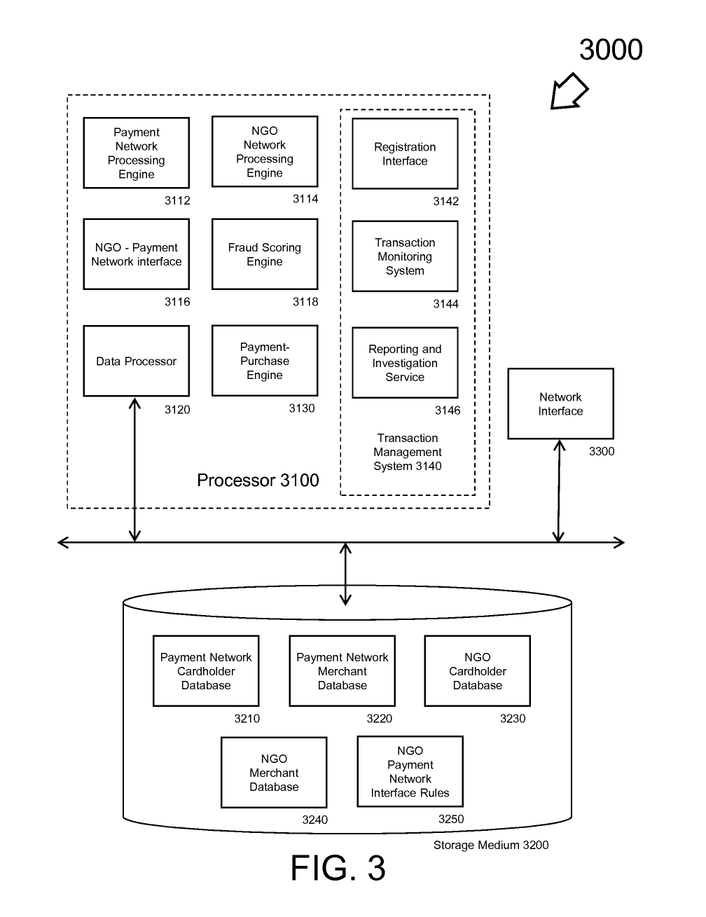

Embodiments will now be disclosed with reference to a block diagram of an exemplary payment network 3000 of FIG. 3 configured to process financial transactions that traverse an NGO network with an interbank network, constructed and operative in accordance with an embodiment of the present disclosure.

Payment network 3000 may run a multi-tasking operating system (OS) and include at least one processor or central processing unit (CPU) 3100, a non-transitory computer-readable storage medium 3200, and a network interface 3300.

Processor 3100 may be any central processing unit, microprocessor, micro-controller, computational device or circuit known in the art. It is understood that processor 3100 may communicate with and temporarily store information in Random Access Memory (RAM) (not shown).

As shown in FIG. 3, processor 3100 is functionally comprised of a payment network processing engine 3112, NGO network processing engine 3114, NGO-payment network interface 3116, a fraud scoring engine 3118, a payment purchase engine 3130, a transaction management system 3140, and a data processor 3120.

Payment network processing engine 3112 is the structure that enables the payment network 3000 to communicate with and process data and/or transactions via the interbank network 2100, including from acquirer 2200 and issuer 2300.

NGO network processing engine 3114 is any structure that enables the payment network 3000 to communicate with and process data and/or transactions via the NGO network 1100, including from merchants 1110, ATMs 1120, and the non-governmental organization 1200.

NGO-payment network interface 3116 the structure that allows payment network processing engine 3112 and NGO network processing engine 3114 to communicate with each other. NGO-payment network interface 3116 may apply a set of rules that govern the types of transactions that may occur between payment network processing engine 3112 and NGO network processing engine 3114. These rules may be referred to as NGO-payment network interface rules 3250.

Fraud scoring engine 3118 is a structure that scores financial transactions from payment network processing engine 3112 and/or NGO network processing engine 3114 for fraud. Fraud scoring engine 3118 may use decision tree logic, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Payment-purchase engine 3130 may be any structure that facilitates payment from customer accounts at an issuer 2300, or NGO 1200 to a ATM 1120/2120 or merchant 1110/2110. The customer accounts may include payment card accounts, checking accounts, savings accounts and the like.

Transaction management system 3140 is configured to manage the NGO transactions on an NGO network 1100. In some embodiments, transaction management system 3140 further comprises: registration interface 3142, transaction monitoring system 3144, and reporting and investigation service 3146.

Registration interface 3142 is a structure that allows the program manager to establish the NGO program rules, such as identifying registered merchants and aid recipients, and enable their participation through the provision or sanction of an appoint of sale system and voucher, respectively.

Transaction monitoring system 3144 enables a merchant point of sale device (POS) to validate the authenticity of a voucher, grants aid recipients permission to use the voucher, and verifies the appropriateness of the merchant/aid-recipient combination, In some embodiments, the transaction monitoring system 3144 further enables an aid recipient or merchant 1110 to determine the balance on the voucher and the available commodities for the aid recipient, and tracking of completed transactions that use the voucher.

Reporting and investigation service 3146 is the electronic service that allows transactions to be monitored and allows registered entities to audit, investigate, analyze, and report transaction activity. In some embodiments this functionality includes the program management capability to interface with payment-purchase engine 3130, to compensate a merchant 1110 for goods and services rendered.

Data processor 3120 enables processor 3100 to interface with storage medium 3200, network interface 3300 or any other component not on the processor 3100. The data processor 3120 enables processor 3100 to locate data on, read data from, and write data to these components.

These structures may be implemented as hardware, firmware, or software encoded on a computer readable medium, such as storage medium 3200. Further details of these components are described with their relation to method embodiments below.

Network interface 3300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 3300 allows payment network 3000 to communicate with vendors, cardholders, and/or issuer financial institutions.

Computer-readable storage medium 3200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 3200 may be remotely located from processor 3100, and be connected to processor 3100 via a network such as a local area network (LAN), a wide area network (WAN), or the Internet.

In addition, as shown in FIG. 3, storage medium 3200 may also contain a payment network cardholder database 3210, payment network merchant database 3220, NGO cardholder database 3230, NGO merchant database 3240, and NGO payment network interface rules 3250. Payment network cardholder database 3210 is configured to store payment cardholder information, such as payment card and account information, transaction information related to cardholder accounts, and any other payment cardholder-related information. Payment network merchant database 3220 is configured to store merchant information, such as merchant account information. A NGO cardholder database 3230 is configured to store NGO payment cardholder information, such as NGO payment card and account information, NGO transaction information related to NGO cardholder accounts, and any other NGO payment cardholder-related information. NGO merchant database 3240 is configured to store NGO-approved merchant information, such as their account information. As described above, NGO-payment network interface rules 3250 include a set of rules and restrictions that govern the types of transactions that may occur between payment network processing engine 3112 and NGO network processing engine 3114 (“cross-network interface rules”). For illustrative purposes only, example NGO-payment network interface rules 3250 may include limitations on the types of merchants that an NGO-aid-recipient may pay outside the NGO network 1100; for example, the NGO-aid recipient may be restricted to purchases of food or temporary shelter. Another example limitation may include the amount of cash that an NGO-aid-recipient may withdraw from an ATM 2120 outside the NGO network 1100.

These structures may be implemented as hardware, firmware, or software encoded on a non-transitory computer readable medium, such as storage media. Further details of these components are described with their relation to method embodiments below.

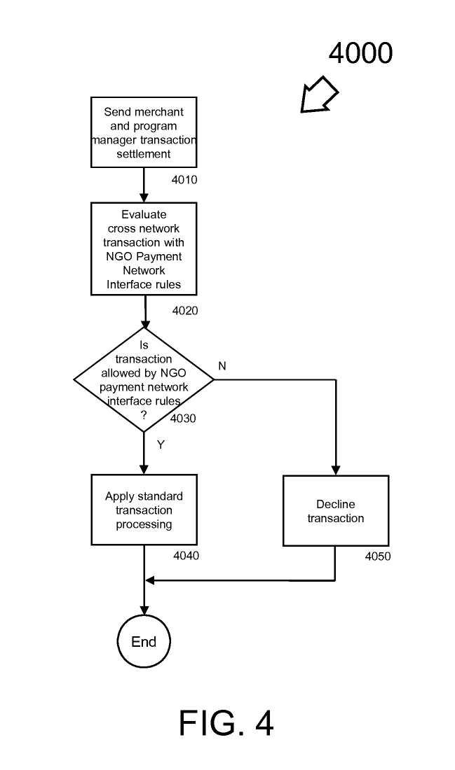

It is understood by those familiar with the art that one or more of these databases 3210-3250 may be combined in a myriad of combinations. The function of these structures may best be understood with respect to the data flow diagram of FIG. 4, as described below.

We now turn our attention to the method or process embodiments of the present disclosure described in the flow chart of FIG. 4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 4 is a flow chart of a method 4000 of performing a financial transaction that crosses the NGO network 1100 with the interbank network 2100, constructed and operative in accordance with an embodiment of the present disclosure. A cross network transaction is any transaction that occurs from an NGO network 1100 to an interbank network 2100, or vice versa. Examples of financial transactions that cross the NGO network with the interbank network include, but are not limited to: persons from the developed world depositing money into an NGO-aid-recipient's NGO account, an NGO-aid-recipient making an NGO payment card transaction outside the NGO network 1100 (e.g. at a merchant 2110 that uses an acquirer 2200 on an interbank network 2100), and/or a standard (i.e., interbank network) payment cardholder making a purchase transaction at an NGO-approved merchant 1110.

Initially, at block 4010, payment network 3000 receives a cross network transaction. The cross network transaction may be initially received by the network interface 3300, which forwards the transaction to either the payment network processing engine 3112 or NGO network processing engine 3114, as is appropriate. The cross network transaction data includes: a cardholder identifier (which may be a Primary Account Number (PAN) or other unique payment card identifier), a merchant identifier, an issuer identifier, an identifier for the type of transaction taking place (a transaction type identifier), and a transaction amount. In cases where a Primary Account Number serves as the cardholder identifier, the first six digits of the PAN identifies the issuer; these six digits of the PAN are referred to as an Issuer Identification Number (IIN) or Bank Identification Number (BIN). The BIN is an issuer identifier; the issuer identifier indicates whether the issuer is on an NGO network 1100 or an interbank network 2100. Similarly, the merchant identifier indicates whether the merchant 1110/2110 (or the merchant's acquirer 2200) is on the NGO network 1100 or the interbank network 2100.

Comparison between the cardholder identifier (or issuer identifier) and the merchant identifier allows payment network 3000 to determine that the transaction is a cross network transaction. It is understood that payment network merchant database 3220, NGO cardholder database 3230, and/or NGO merchant database 3240 may be consulted to determine that the transaction is a cross network transaction.

The transaction type identifier indicates whether the transaction is a purchase, a return, a cash withdrawal, a deposit, and so on.

Once identified as a cross network transaction, at block 4020, NGO-payment network interface 3116 evaluates the financial transaction and determines whether the transaction complies with the NGO payment network interface rules 3250. Typically, the NGO-payment network interface 3116 examines the type of transaction taking place (via the transaction type identifier), the transaction amount, and the parties involved in the transaction (the issuer, the merchant, and the cardholder) in making the determination. For example, in some embodiments, an interbank network cardholder or account holder may always be able to deposit value on to an NGO payment card account. In other embodiments, an NGO payment card account may be restricted to purchases from grocery stores when shopping from a non-NGO network merchant 2110. In addition to deposits and restricted merchant categories outside the NGO network, additional stipulations for cross network transactions may include:

Geographic limitations
Time limitations (e.g., time of day, time since disaster)

When the NGO-payment network interface 3116 determines that the transaction complies with the NGO payment network interface rules 3250, at decision block 4030, standard transaction processing applies, block 4040—the transaction is scored by fraud scoring engine, and forwarded on the issuer of the payment card for approval/decline. If the payment card is a standard payment card on an interbank network 2100, the transaction is forwarded to issuer 2300. When the payment card is an NGO-issued payment card on the NGO network 1100, the transaction may be forwarded to NGO 1200.

When the NGO-payment network interface 3116 determines that the transaction does not comply with the NGO payment network interface rules 3250, at decision block 4030, the transaction is automatically declined, at block 4050.

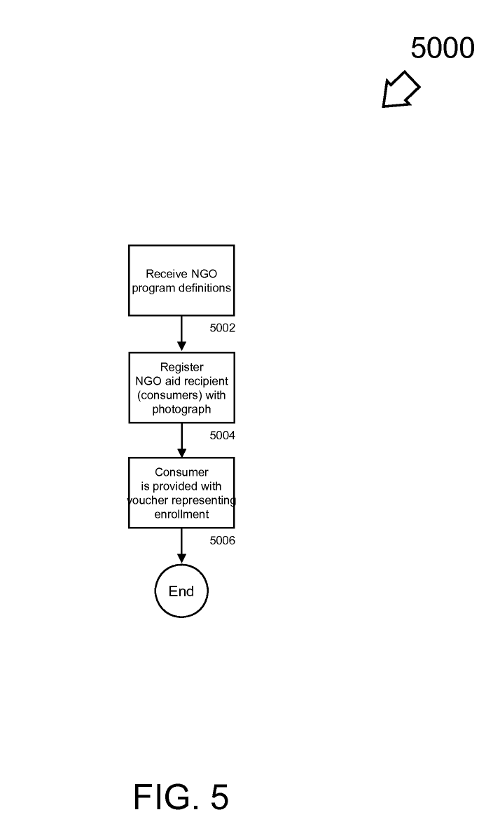

FIG. 5 is a flow chart of process 5000 to register a voucher aid program in a transaction management system, constructed and operative in accordance with an embodiment of the present disclosure.

At block 5002, registration interface 3142 receives NGO program definitions from a program manager via network interface 3300. NGO program definitions includes a program duration, commodities and quantities allowed for purchase, and participating merchants. The NGO merchant database 3240 and NGO payment network interface rules 3250 are appropriately updated with the program definitions.

Once the NGO program definitions are updated, the program manager can provide a list of NGO aid recipients to register them into the system, block 5004. In some embodiments, the list of NGO aid recipients is provided with the aid recipients' photographs. Depending upon the aid program objectives, the program registration may include the collection of demographic and economic data. The NGO cardholder database 3230 is updated to reflect the provided NGO aid recipients and their associated photographs. The photographs may be used to identify aid recipients at the point of sale.

At block 5006, the voucher is generated by the transaction management system 3140. In some embodiments, the voucher is an electronic payment card, identification number, or electronic token on a mobile phone or other device. [INVENTORS: DO WE WANT TO ELABORATE ON THE VOUCHER FORMAT?] The voucher may then be distributed to the aid recipient.

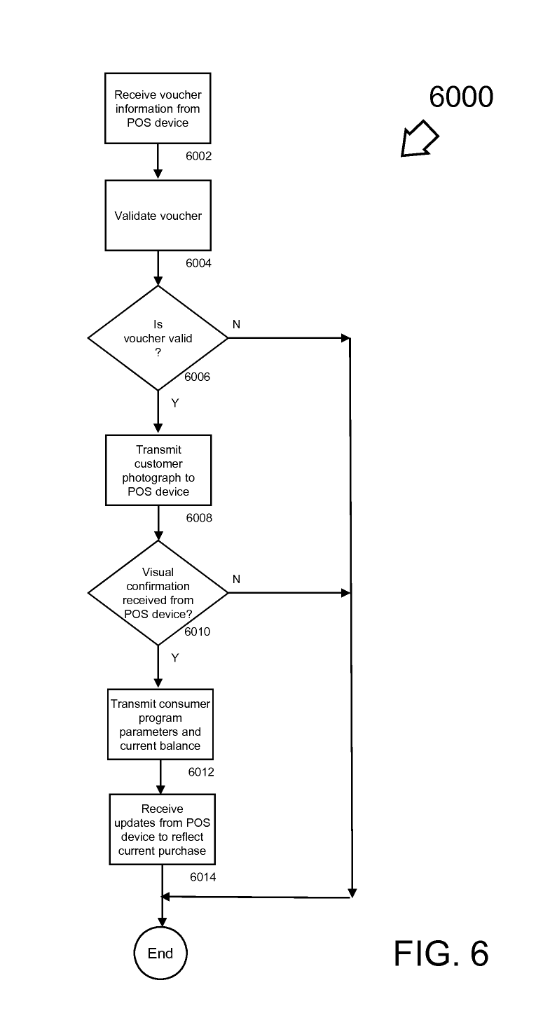

FIG. 6 is a flow chart depicting a purchase transaction method using the transaction management system 3140, constructed and operative in accordance with an embodiment of the present disclosure.

At block 6002, the transaction management system 3140 receives a transaction and voucher information from a merchant point of sale device. For example, a voucher payment card might be swiped, dipped, or tapped. In some embodiments, a QR code or altphanumeric code may be typed or read. The transaction information includes a merchant identifier, while the voucher information includes a customer identifier.

The voucher information is compared with the NGO cardholder database 3230 to validate the voucher, block 6004.

If the voucher is determined to be valid, at block 6006, the process flow continues at block 6008. Otherwise, the process 6000 ends.

At block 6008, the transaction management system 3140 retrieves a photograph of the aid recipient from NGO cardholder database 3230, and transmits the photograph to the point of sale device, to allow visual confirmation of the aid recipient by the merchant 1110. This allows merchant 1110 to compare the photograph of the aid recipient that was loaded into the NGO cardholder database 3230 at the time of registration. The merchant is then able to compare the photograph on the point of sale device against the person presenting the voucher, and if printed on the voucher, a second photograph. If all three images match, the transaction may continue.

When an electronic indicator of the visual confirmation is received from the point of sale device, as determined at decision block 6010, the process continues at block 6012. Otherwise, the process 6000 ends.

At block 6012, the transaction management system 3140 transmits the aid recipient's program parameters and current voucher balance. The aid recipient's program parameters may be retrieved by using a merchant identifier. For example, if the program is a restricted commodity program, then the point of sale device may display an image of each commodity with the previous purchased quantities crossed out. If the program was a restricted merchant program, the point of sale would display the current balance available of credits at the merchant and may do so alpha-numerically or visually.

The transaction management system 3140 receives updates to reflect current purchases from the point of sale device, block 6014.

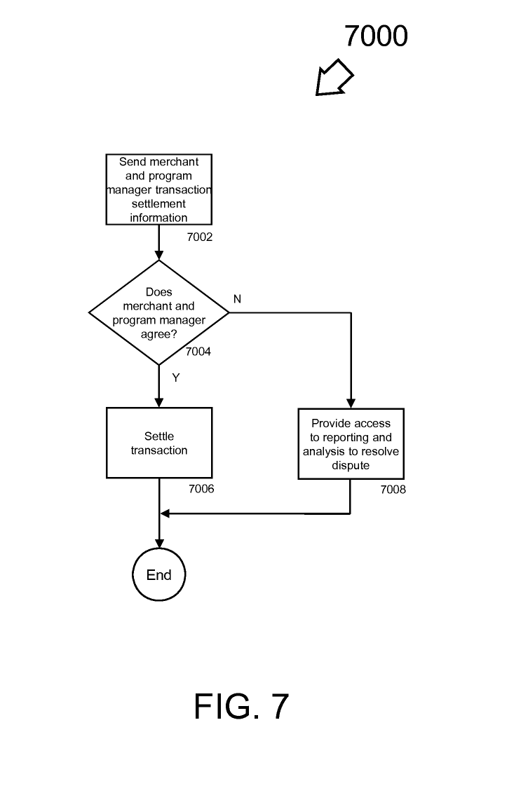

FIG. 7 is a flow chart of a method of a settlement method 7000 in the transaction management system, constructed and operative in accordance with an embodiment of the present disclosure. Process 7000 is usually a batch-process, but in some embodiments may be a real-time process.

At the end of a pre-defined period of time, the transaction management system 3140 electronically sends the merchant 1110 and program manager transaction settlement information via network interface 3300, block 7002. The electronic settlement information may include the statistics for the merchant's services to the program manager.

If the merchant and the program manager electronically agree on the report, as determined at block 7004. then the transaction is settled at block 7006 and the payment purchase engine 3130 is used to process the payment to merchant 1110.

If the merchant and the program manager cannot electronically agree on the report, as determined at block 7004. the merchant 1110 and program manager are provided access to reporting and analysis via the reporting and investigation service 3146 to resolve the dispute. [INVENTORS: IF WE WANT TO CLAIM THE REPORTING AND INVESTIGATION SERVICE, WE WILL HAVE TO ELABORATE ON DETAILS.]

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and features disclosed herein.

What is claimed is:

1. A method of processing a non-governmental organization (NGO) aid transaction, the method comprising:
receiving the aid transaction from a point-of-sale (POS) device via a network interface, the aid transaction containing: a cardholder identifier, and a merchant identifier;
validating, with a processor, the cardholder identifier;
using the cardholder identifier to retrieve, with the processor, a photograph of a cardholder associated with the cardholder identifier from a database stored on a non-transitory computer-readable storage medium;
transmitting, with the network interface, the photograph of the cardholder to the point-of-sale device.

2. The method of claim 1, further comprising:
using the merchant identifier to retrieve, with the processor, consumer program parameters associated with the cardholder identifier.

3. The method of claim 2 further comprising:
transmitting, with the network interface, the consumer program parameters to the point-of-sale device when a visual confirmation of the photograph is received from point-of-sale device.

4. The method of claim 3 wherein the consumer program parameters include a list of commodities that are permitted to be purchased.

5. The method of claim 4 further comprising:
using the cardholder identifier to retrieve, with the processor, a current balance associated with the cardholder identifier from a database stored on a non-transitory computer-readable storage medium.

6. The method of claim 5 further comprising:
further transmitting, with the network interface, the current balance to the point-of-sale device when a visual confirmation of the photograph is received from point-of-sale device.

7. The method of claim 6 further comprising:
receiving an update message from the point-of-sale device indicating a current purchase;
updating the current balance in the database based on the current purchase.

8. An apparatus to process a non-governmental organization (NGO) aid transaction, the apparatus comprising:
a network interface configured to receive the aid transaction from a point-of-sale (POS) device, the aid transaction containing: a cardholder identifier, and a merchant identifier;
a processor configured to validate the cardholder identifier, to use the cardholder identifier to retrieve a photograph of a cardholder associated with the cardholder identifier from a database stored on a non-transitory computer-readable storage medium;
the network interface further configured to transmit the photograph of the cardholder to the point-of-sale device.

9. The apparatus of claim 8, wherein the processor is further configured to use the merchant identifier to retrieve consumer program parameters associated with the cardholder identifier.

10. The apparatus of claim 9, wherein the network interface is further configured to transmit the consumer program parameters to the point-of-sale device when a visual confirmation of the photograph is received from point-of-sale device.

11. The apparatus of claim 10, wherein the consumer program parameters include a list of commodities that are permitted to be purchased.

12. The apparatus of claim 11 wherein the processor is further configured to use the cardholder identifier to retrieve a current balance associated with the cardholder identifier from a database stored on a non-transitory computer-readable storage medium.

13. The apparatus of claim 12 wherein the network interface is further configured to transmit the current balance to the point-of-sale device when a visual confirmation of the photograph is received from point-of-sale device.

14. The apparatus of claim 13 wherein the network interface is further configured to receive an update message from the point-of-sale device indicating a current purchase, and to update the current balance in the database based on the current purchase.

15. A non-transitory computer-readable storage medium encoded with data and instructions that when the instructions are executed by a computing device, causes the computing device to:
receive the aid transaction from a point-of-sale (POS) device via a network interface, the aid transaction containing: a cardholder identifier, and a merchant identifier;
validate, with a processor, the cardholder identifier;
use the cardholder identifier to retrieve, with the processor, a photograph of a cardholder associated with the cardholder identifier from a database stored on the non-transitory computer-readable storage medium;
transmit, with the network interface, the photograph of the cardholder to the point-of-sale device.

16. The non-transitory computer-readable storage medium of claim 15, wherein the instructions further causes the computing device to:
use the merchant identifier to retrieve, with the processor, consumer program parameters associated with the cardholder identifier.

17. The non-transitory computer-readable storage medium of claim 16 wherein the instructions further causes the computing device to:
transmit, with the network interface, the consumer program parameters to the point-of-sale device when a visual confirmation of the photograph is received from point-of-sale device.

18. The non-transitory computer-readable storage medium of claim 17, wherein the consumer program parameters include a list of commodities that are permitted to be purchased.

19. The non-transitory computer-readable storage medium of claim 18, wherein the instructions further causes the computing device to:
use the cardholder identifier to retrieve, with the processor, a current balance associated with the cardholder identifier from a database stored on a non-transitory computer-readable storage medium.

20. The non-transitory computer-readable storage medium of claim 19 wherein the instructions further causes the computing device to:
further transmit, with the network interface, the current balance to the point-of-sale device when a visual confirmation of the photograph is received from point-of-sale device.
